(19) United States
(12) Patent Application Publication
(10) Pub. No.: US 2019/0153981 A1
(43) Pub. Date: May 23, 2019

(54) THRUSTER WITH COMBUSTION CHAMBER AND NOZZLE USING HONEYCOMB STRUCTURE

(71) Applicant: KOREA AEROSPACE RESEARCH INSTITUTE, Daejeon (KR)

(72) Inventor: Jongwon CHAE, Daejeon (KR)

(21) Appl. No.: 16/184,209

(22) Filed: Nov. 8, 2018

(30) Foreign Application Priority Data
Nov. 9, 2017 (KR) 10-2017-0148572

(51) Int. Cl. F02K 9/97

(52) U.S. Cl. CPC F02K 9/974

(57) ABSTRACT

The present invention relates to a thruster having a combustion chamber and a nozzle portion using a honeycomb structure, and more particularly, to a thruster having a combustion chamber and a nozzle portion using a honeycomb structure in which a wall reinforcement including honeycomb structures and heat-resistant paints provided in the honeycomb structures are bonded to a wall constituting a combustion chamber portion and a nozzle portion to increase durability and strength against a mechanical load such as vibrations, impact, or the like, due to combustion of a high-temperature and high-speed propellant and a heat-fluid load such as heat transfer and a temperature load, and a thickness of the wall of the existing combustion chamber and nozzle portion may thus be decreased, such that a weight of the thruster may further be decreased and durability of the wall may be increased.

### CROSS-REFERENCE TO RELATED APPLICATIONS

The present application claims priority under 35 U.S.C. § 119 to Korean Patent Application No. 10-2017-0148572 entitled “THRUSTER HAVING COMBUSTION CHAMBER AND NOZZLE PORTION USING HONEYCOMB STRUCTURE”, filed on Nov. 9, 2017. The entire contents of above-listed application are hereby incorporated by reference in its entirety for all purposes.

### TECHNICAL FIELD

The following disclosure relates to a thruster having enhanced resistance to heat, oxidation, and a temperature load using a honeycomb structure in a combustion chamber and a nozzle portion combusting and discharging a high-temperature and high-speed propellant.

### BACKGROUND

An vehicle such as an artificial satellite and a rocket projectile loses an attitude balance or is out of orbit due to disturbance due to disturbance during performance of mission. In this case, in order for the vehicle to normally perform the mission, an appropriate impulse is given to the vehicle to allow the vehicle to follow a set orbit and attitude balance. A thruster is used in order to perform such a function.

Particularly, the thruster used in the vehicle such as the artificial satellite and the rocket projectile discharges a high-temperature and high-speed propellant, and thus, is preferably formed of a material having high strength in a high temperature and temperature load. Recently, in order to decrease a weight of the thruster using a titanium alloy, the use of the titanium alloy has increased throughout a military field or an aviation industry field.

However, the titanium alloy, which is a material having a high reactivity, has high combustion heat and low thermal conductivity, and is spontaneously ignited and combusted even at a melting temperature or less. Further, since an amount of heat conducted into the titanium alloy at the time of exposing the titanium alloy to a high-temperature gas is relatively small as compared with other metals, only a surface of the titanium alloy is rapidly heated, such that the titanium alloy may be locally melted. Therefore, it is difficult to use the titanium alloy in a nozzle portion and a combustion chamber of the thruster exposed to a high-temperature and high-speed combustion gas atmosphere.

In order to solve the problem as described above, Korean Patent Laid-Open Publication No. 10-2012-0027864 (published on Mar. 22, 2012) has disclosed a nozzle device in which heat-resistance coating is applied to inner walls of a nozzle portion and a combustion chamber of a thruster. However, the thruster having the nozzle device according to the related art does not have sufficient strength against a temperature load by combustion of a high-temperature and high-speed propellant generated in the nozzle portion and the combustion chamber, such that walls constituting the nozzle portion and the combustion chamber are designed and manufactured at a great thickness, and thus, a problem that an appropriate decrease in a weight of the thruster may not be implemented may not be overcome.

### RELATED ART DOCUMENT

### Patent Document

Korean Patent Laid-Open Publication No. 10-2012-0027864 (published on Mar. 22, 2012)

### SUMMARY

An embodiment of the present invention is directed to providing a thruster having enhanced resistance to heat, oxidation, and a temperature load by combustion of a propellant for propelling an airplane by forming a reinforcing structure having honeycomb structures on an outer surface of a wall constituting a nozzle portion and a combustion chamber in the thruster having the nozzle portion discharging the propellant and the combustion chamber connected to the nozzle portion and combusting the propellant.

In one general aspect, a thruster having a combustion chamber and a nozzle portion using a honeycomb structure, the nozzle portion discharging a propellant for propelling an vehicle and the combustion chamber connected to the nozzle portion and combusting the propellant, includes: a wall constituting walls of the nozzle portion and the combustion chamber; and a wall reinforcement formed on an outer surface of the wall and including a plurality of honeycomb structures continued along the outer surface of the wall.

Heat-resistant paints for protecting the wall from heat generated due to the combustion of the propellant may be applied to internal spaces of the honeycomb structures hollowed from an outer surface of the wall reinforcement toward the wall.

The heat-resistant paints may have different emittances, respectively, depending on a heat load amount applied to the wall.

The heat-resistant paints may be formed, respectively, at different sizes depending on a heat load amount applied to the wall.

The wall reinforcement may be manufactured on the outer surface of the wall using metal stack manufacturing (3D printing).

In the wall reinforcement, the honeycomb structures may be alternated to form layers.

### BRIEF DESCRIPTION OF THE DRAWINGS

FIG. 1 is a perspective view illustrating a thruster according to the related art.

FIG. 2 is a cross-sectional view illustrating a nozzle portion and a combustion chamber of FIG. 1.

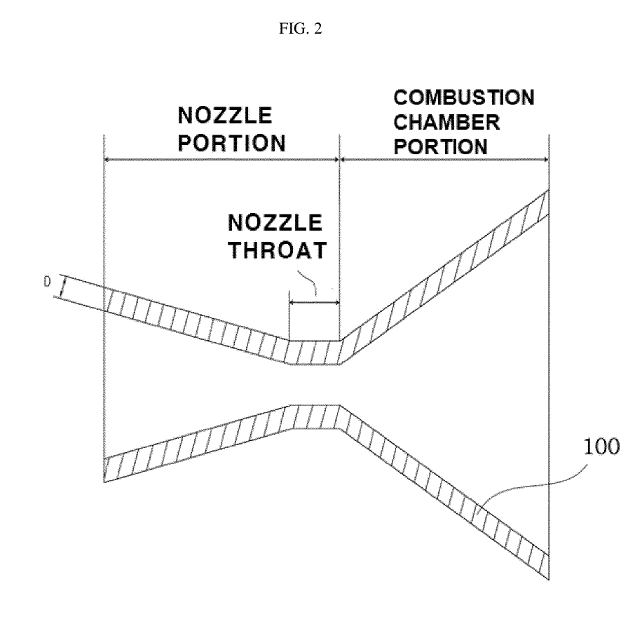

FIG. 3 is a perspective view illustrating a nozzle portion and a combustion chamber according to an exemplary embodiment of the present invention.

FIG. 4 is a cross-sectional view taken along line A-A′ of FIG. 3.

FIGS. 5A and B relate to a graph illustrating a heat load amount applied to a wall according to the present invention.

FIGS. 6A and 6B are front views illustrating a manufacturing sequence of a thruster according to an exemplary embodiment of the present invention.

FIGS. 7A and 7B are front views illustrating another example of a wall reinforcement according to the present invention.

FIG. 8 is an illustrative view illustrating another example of honeycomb structures according to the present invention.

### DETAILED DESCRIPTION OF EMBODIMENTS

Hereinafter, the technical spirit of the present invention will be described in more detail with reference to the accompanying drawings.

The accompanying drawings are only examples illustrated in order to describe the technical idea of the present invention in more detail. Therefore, the technical idea of the present invention is not limited to forms of the accompanying drawings.

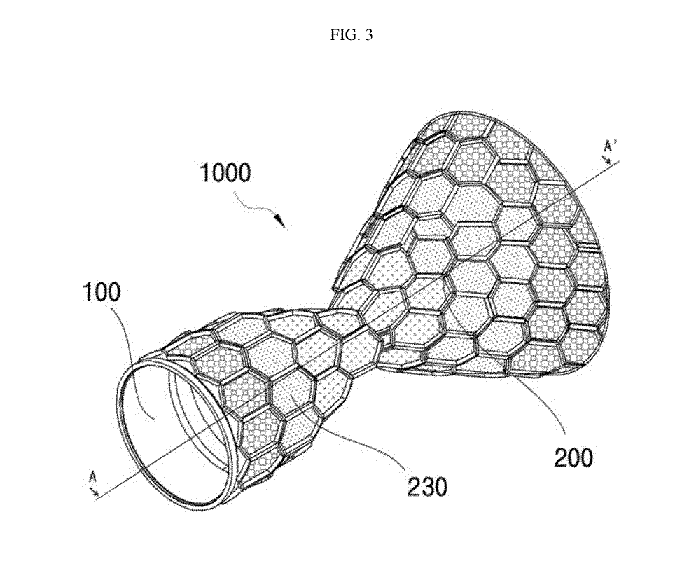

FIG. 3 is a perspective view illustrating a nozzle portion and a combustion chamber portion of a thruster 1000 according to an exemplary embodiment of the present invention. Referring to FIG. 3, the thruster 1000 may be configured to include a wall 100, a wall reinforcement 200, and heat-resistant paints 230.

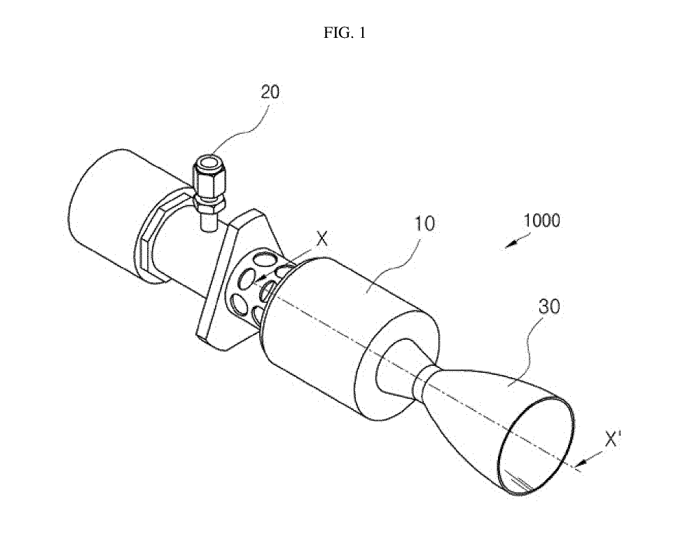

The thruster 1000 is provided in an vehicle having a high temperature and a high pressure resistance, such as an artificial satellite or a rocket projectile to combust a propellant so that the vehicle has a thrust. Referring to FIG. 1, the thruster according to the related art including a catalyst reactor 10, a propellant injection portion 20, and a nozzle 30 is illustrated, but the thruster 1000 according to an exemplary embodiment of the present invention may be variously modified without departing from the gist of the present invention.

The wall 100, which constitutes walls of a nozzle portion discharging a propellant for propelling the vehicle and a combustion chamber connected to the nozzle portion and combusting the propellant, may be formed of any material such as a glass fiber, a carbon composite material titanium alloy, aluminum, and the like, that may be used in the thruster of the vehicle such as the artificial satellite, the rocket projectile, or the like, be lightweight, and have excellent durability.

The wall reinforcement 200 may be formed on an outer surface of the wall 100, and may include a plurality of honeycomb structures 210 continued along the outer surface of the wall 100. In addition, the wall reinforcement 200 is formed on only the outer surface of the wall in the drawing, but may also be formed on an inner surface of the wall 100.

The honeycomb structures 210, which are formed on the outer surface of the wall 100 to enhance resistance to a mechanical load such as vibrations transferred to the wall 100, impact, and the like, may be formed as structures having various shapes on the outer surface of the wall 100, and shapes, sizes, heights, and the like, of the honeycomb structures 210 may be determined through structure analysis and heat-fluid analysis depending on a heat load amount applied to the wall 100.

In addition, a hexagonal honeycomb shape is the most economical structure in which a maximum space may be secured with a minimum material and is a stable structure in which force is distributed in the most balanced manner, and it is preferable that the wall reinforcement 200 is formed by collecting the plurality of honeycomb structures 210 formed in the hexagonal honeycomb shape.

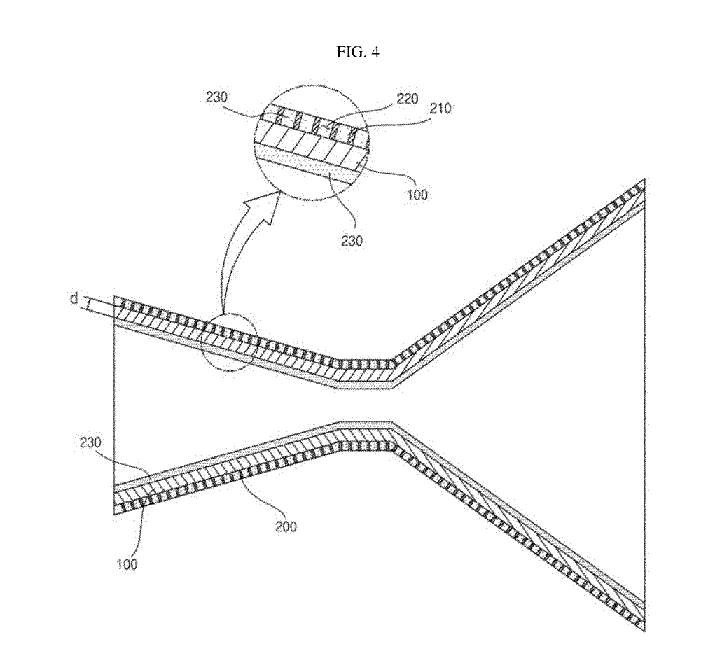

FIG. 4 is a cross-sectional view taken along line A-A′ of FIG. 3. Referring to FIG. 4, the wall 100 may be configured to include the nozzle portion and the combustion chamber portion formed on the inner surface thereof, and may be formed in a tapered shape in which diameters of the nozzle portion and the combustion chamber portion become gradually large on the basis of a nozzle throat formed at a point at which the nozzle portion and the combustion chamber portion are connected to each other. In this case, the nozzle portion may be formed so that the diameter thereof becomes gradually small in order to increase discharge pressure of the propellant discharged by the nozzle portion, and the combustion chamber portion may be formed so that the diameter thereof becomes gradually large in order to rapidly increase a discharge area of the propellant at the nozzle throat to increase complete combustion efficient. In this case, it is preferable that the wall reinforcement 200 is formed depending on a shape of the outer surface of the wall 100.

A ceramic coating material may be coated on the inner surface of the wall 100 in order to increase heat resistance and oxidation resistance, and the wall reinforcement 200 may be formed on the outer surface of the wall 100.

In this case, in each of the honeycomb structures 210 forming the wall reinforcement 200, an internal space 220 of which an inner portion is hollowed from an outer surface of the wall reinforcement 200 in a direction perpendicular to the outer surface of the wall 100 may be formed. In this case, the honeycomb structure 210 may have a predetermined thickness, and may be formed to be continued to another adjacent honeycomb structure 210.

In addition, in the wall reinforcement 200, the heat-resistant paint 230 provided in the internal space 220 and formed of ceramic having heat resistance may be formed.

The heat-resistant paint 230, which is formed of a material having a high thermal emittance and a low solar absorbance and suppresses heat conduction of the wall 100 to improve heat resistance of the wall 100, may be provided in the internal space 220 of the wall reinforcement 200, such that the wall 100 having resistance to a mechanical load and a heat-fluid load may be formed.

Due to the configuration as described above, a wall thickness d of the wall 100 may be designed to be smaller than a wall thickness D of the nozzle and the combustion chamber according to the related art, such that a weight of the thruster 1000 may further be decreased.

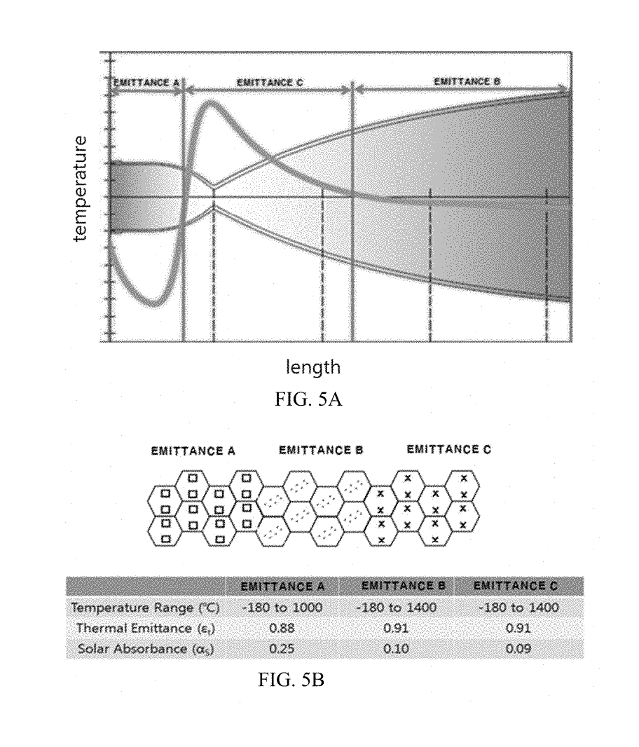

FIG. 5A is a graph illustrating a heat load amount applied to the wall 100 by combustion of the propellant at the time of an operation of the vehicle, and FIG. 5B is an illustrative view illustrating that different emittances are applied to the heat-resistant paint 230 depending on the heat load amount of FIG. 5A. Referring to FIGS. 5A and 5B, it may be seen that a heat load amount applied to the nozzle throat is the highest, and a heat load amount is gradually decreased as a distance form the nozzle throat is increased. In this case, the wall 100 is formed of an alloy to which platinum having high heat resistance and oxidation resistance is added, and it may be seen that the wall 100 may partially allow a temperature up to 1600° C. (2900° F.). In this case, it is preferable that the wall reinforcement 200 is formed of a platinum alloy to which platinum is added.

Therefore, the wall reinforcement 200 and the heat-resistant paint 230 provided on the wall 100 may be formed to have different emittances depending on the heat load amount applied to the wall 100. In this case, as illustrated in FIGS. 5A and 5B, emittance A means a section having the lowest heat load amount, emittance B means a section having a constant heat load amount in the combustion chamber, and emittance C means a section having the highest heat load amount in the nozzle throat.

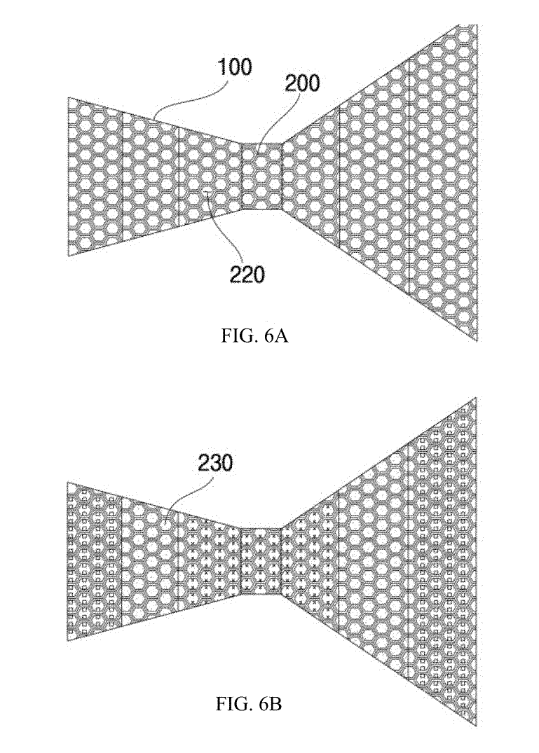

FIGS. 6A and 6B are front views illustrating a method of manufacturing the thruster 1000 according to an exemplary embodiment of the present invention. The method of manufacturing the thruster 1000 according to an exemplary embodiment of the present invention will be described in detail with reference to FIGS. 6A and 6B.

FIG. 6A is a front view illustrating that the wall reinforcement 200 having the honeycomb structures 210 is bonded to the wall 100 constituting the nozzle portion and the combustion chamber portion. In this case, the wall reinforcement 200 may be manufactured by a metal stack manufacturing (3D printing) method. The metal stack manufacturing (3D printing) method is a method of stacking end surfaces of the wall 100 and the wall reinforcement 200 designed by vacuum-melting metals, which are raw materials, to form alloys and then spraying the alloys together with a high-pressure inert gas through a nozzle, one by one. In this case, a surface to be formed is guided by scanning using a laser beam, an electron beam, or the like, until a shape becomes a shape of a final component, and whenever a laser beam having a fine diameter passes along a guided line and surface, metal powders are locally melted and another layer is stacked on the previously stacked surface, and the wall 100 and the wall reinforcement 200 may be manufactured integrally with each other.

In this case, the heat-resistant paint 230 may be formed by filling an inner portion of the internal space 220 of each honeycomb structure 210 of the wall reinforcement 200 with a paint melted in a state in which ceramic having heat resistance and a silicate binder are added. In this case, the silicate binder may serve as a binder allowing the heat-resistant paint 230 to be bonded to the wall 100 and the wall reinforcement 200, and the heat-resistant paint 230 may be hardened to coat the wall 100 and the wall reinforcement 200. In this case, the heat-resistant paint 230 may be filled and formed by a height of the internal space 220 of the wall reinforcement 200, and is preferably applied to coat all of the internal space 200 and the outer surfaces of the wall 100 and the wall reinforcement 200. In addition, since a liquefied paint is used as the heat-resistant paint 230, the heat-resistant paint 230 may be stacked and manufactured together with the wall 100 and the wall reinforcement 200 by the metal stack manufacturing (3D printing) method.

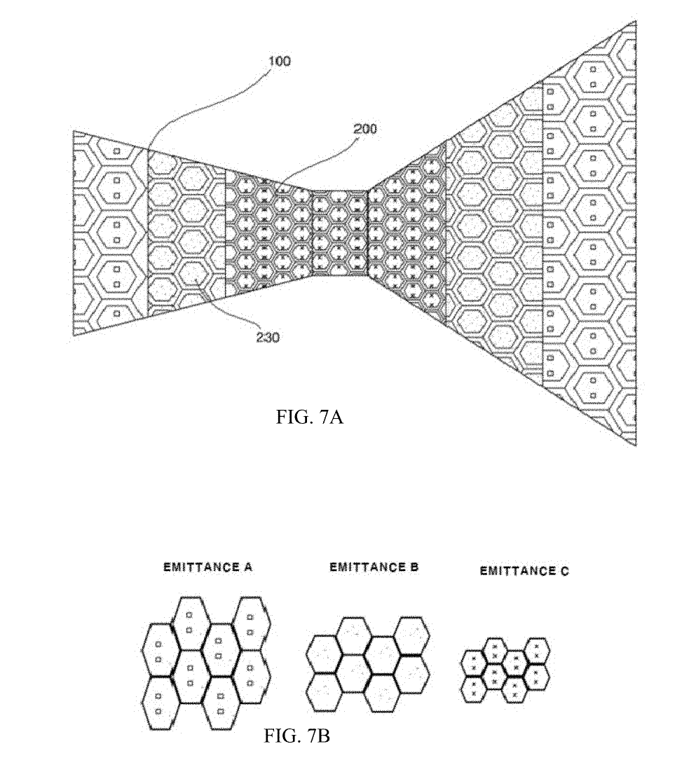

FIGS. 7A and 7B are front views illustrating another example of the wall reinforcement 200 according to the present invention. Referring to FIGS. 7A and 7B, the honeycomb structures 210 of the wall reinforcement 200 may have different sizes depending on heat load amounts applied to the wall 100. In this case, it is preferable to form the honeycomb structures 210 having sizes that become gradually small in a sequence of emittance A, emittance B, and emittance C, and a load due to a high temperature load at the nozzle throat of the wall 100 may be more effectively prevented due to the configuration as described above.

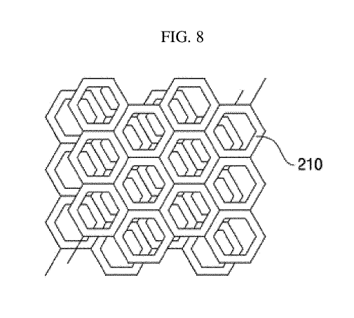

FIG. 8 is an illustrative view illustrating another example of the honeycomb structures 210 according to the present invention. Referring to FIG. 8, the honeycomb structures 210 are alternated to form layers, resulting in improvement of strength against a mechanical load such as vibrations, impact, or the like, applied to the wall 100, and the honeycomb structures 210 are alternated, such that an effect of having resistance to heat and oxidation in the heat-resistant paint 230 may be maintained.

In the thruster 1000 having the combustion chamber and the nozzle portion using the honeycomb structure according to the present invention, having the configuration as described above, the honeycomb structures 210 are bonded to the wall constituting the combustion chamber portion and the nozzle portion to increase durability and strength against a mechanical load such as vibrations, impact, or the like, due to combustion of a high-temperature and high-speed propellant and a heat-fluid load such as heat transfer and a temperature load, and a thickness of the wall of the existing combustion chamber and nozzle portion may thus be decreased, such that a weight of the thruster may further be decreased, and durability of the wall 100 may be increased.

In the thruster having the combustion chamber and the nozzle portion using the honeycomb structure according to the present invention, having the configuration as described above, the honeycomb structures are bonded to the walls of the combustion chamber portion and the nozzle portion to increase durability and strength against a mechanical load such as vibrations, impact, or the like, due to combustion of a high-temperature and high-speed propellant and a heat-fluid load such as heat transfer and a temperature load, and a thickness of the wall of the existing combustion chamber and nozzle portion may thus be decreased, such that a weight of the thruster may further be decreased, and the thruster may be efficient.

The present invention is not limited to the abovementioned exemplary embodiments, but may be variously applied, and may be variously modified without departing from the gist of the present invention claimed in the claims.

### DETAILED DESCRIPTION OF MAIN ELEMENTS

1000: thruster
100: wall
200: wall reinforcement
210: honeycomb structure
220: internal space
230: heat-resistant paint

What is claimed is:

1. A thruster having a combustion chamber and a nozzle portion using a honeycomb structure, the nozzle portion discharging a propellant for propelling an and the combustion chamber connected to the nozzle portion and combusting the propellant, comprising:
a wall constituting walls of the nozzle portion and the combustion chamber; and
a wall reinforcement formed on an outer surface of the wall and including a plurality of honeycomb structures continued along the outer surface of the wall.

2. The thruster having a combustion chamber and a nozzle portion using a honeycomb structure of claim 1, wherein heat-resistant paints for protecting the wall from heat generated due to the combustion of the propellant are applied to internal spaces of the honeycomb structures hollowed from an outer surface of the wall reinforcement toward the wall.

3. The thruster having a combustion chamber and a nozzle portion using a honeycomb structure of claim 2, wherein the heat-resistant paints have different emittances, respectively, depending on a heat load amount applied to the wall.

4. The thruster having a combustion chamber and a nozzle portion using a honeycomb structure of claim 2, wherein the honeycomb structures are formed, respectively, at different sizes depending on a heat load amount applied to the wall.

5. The thruster having a combustion chamber and a nozzle portion using a honeycomb structure of claim 2, wherein the wall reinforcement is manufactured on the outer surface of the wall using metal stack manufacturing (metal additive printing).

6. The thruster having a combustion chamber and a nozzle portion using a honeycomb structure of claim 2, wherein in the wall reinforcement, the honeycomb structures are alternated to form layers.
